(19) United States
(12) Patent Application Publication
(10) Pub. No.: US 2025/0035378 A1
(43) Pub. Date: Jan. 30, 2025

(54) Method and plant for drying workpieces

(71) Applicant: Ecoclean GmbH, Filderstadt (DE)

(72) Inventors: Alexander GENZE, Simmerath (DE); Peter KRIEG, Bad Teinach-Zavelstein (DE); Mike Fronmüller, Nürtingen (DE)

(21) Appl. No.: 18/775,799

(22) Filed: Jul. 17, 2024

(30) Foreign Application Priority Data
Jul. 27, 2023 (DE) 10 2023 120 025.9

(51) Int. Cl. F26B 21/10; F26B 3/02; F26B 21/08

(52) U.S. Cl. CPC F26B 21/10; F26B 3/02; F26B 21/08

(57) ABSTRACT

In order to provide a method for drying workpieces, comprising the following:
introducing at least one workpiece to be dried into a drying chamber;
carrying out at least one hot air drying procedure wherein feed air is fed to the drying chamber and exhaust air is conducted out of the drying chamber, wherein fresh air is fed to the feed air before its entry into the drying chamber;
which, by using information from the drying procedure, enables the process time for the drying procedure to be shortened and/or the energy required for the drying procedure to be reduced, it is proposed that the feeding of fresh air to the feed air is reduced or interrupted during at least one monitoring period, at least one measurement variable characterizing the drying procedure is measured by means of at least one sensor and a measurement signal of the at least one sensor is transferred to an evaluating unit of a control apparatus, and from the evaluation of the measurement signal of the at least one sensor by means of the evaluating unit, an output variable is established which influences the further progression of the method.

### RELATED APPLICATION

The present disclosure relates to the subject matter disclosed in German patent application No. 10 2023 120 025.9 of Jul. 27, 2023 the entire specification of which is incorporated herein by reference.

### FIELD OF THE DISCLOSURE

The present invention relates to a method for drying workpieces, the method comprising the following:
introducing at least one workpiece to be dried into a drying chamber; and
carrying out at least one hot air drying procedure wherein feed air is fed to the drying chamber and exhaust air is conducted out of the drying chamber,
wherein fresh air is fed to the feed air before its entry into the drying chamber.

### BACKGROUND

Such methods for drying workpieces, which comprise at least one hot air drying procedure, are known from industrial component cleaning and represent a central process step in industrial component cleaning.

Essential parameters of the hot air drying procedure are the temperature of the hot air and the process time of the hot air drying procedure and, if relevant, a movement within the drying chamber of the at least one workpiece to be dried.

The temperature to be set for the hot air and/or the temperature range to be set for the hot air depends upon the underlying technical conditions of the drying plant used and upon the material properties of the at least one workpiece to be dried.

The process time of the hot air drying procedure is usually established by means of advance tests in such a way that the at least one workpiece to be dried is guaranteed to be sufficiently dry after completion of the process time.

It is also known, in a method for drying workpieces, to combine a hot air drying procedure with a vacuum drying procedure. In this case, the hot air drying procedure is carried out in such a way that, at the end of the hot air drying procedure, the at the least one workpiece to be dried is warmed up to such an extent that during the subsequent vacuum drying procedure, the residual liquid still present on the workpiece to be dried can be evaporated.

CN 109724398 B discloses a method for drying wood, wherein the condition of the wood and conditions in a drying chamber are acquired by way of sensors and a drying strategy is selected by means of an artificial intelligence.

US 2019/0146476 A1 discloses an industrial drying process wherein an artificial intelligence receives and monitors data from the process sequence.

KR 102177970 B1 discloses a laundry dryer in which an artificial intelligence evaluates data such as the weight of the laundry before and after the drying procedure, the water temperature and the loading of the laundry dryer.

A hot air drying procedure is a very energy-intensive process step. A typical heating output of an industrial drying plant by means of which a hot air drying procedure is carried out is in the order of 20 kW to 30 kW.

Since, for reasons of process safety, the process times for the hot air drying procedure are always selected such that the at least one workpiece to be dried is always sufficiently dry at the end of the process time and/or is sufficiently warm for a vacuum drying procedure following the hot air drying procedure, often too much energy is used for the hot air drying procedure, as a consequence of which there exists a highly promising energy-saving potential.

With known drying methods which contain a hot air drying procedure, the drying processes are not monitored in a targeted manner with measuring technology. The setting of the parameters of the drying procedure, in particular, the hot air temperature and the process time of the hot air drying procedure is based solely upon the results of advance tests and/or empirical values. A quality control of the drying procedure does not take place at all, or at most manually, in the form of a visual check after completion of the drying procedure.

The drying programs of known industrial drying plants are static and cannot react to changing conditions, for example, a changed number of workpieces to be dried, in particular not if these conditions themselves change during the drying procedure.

With the increasing use of additive manufacturing technologies, such as 3D printing, for the production of workpieces, the complexity of workpieces to be dried increases and thus also the requirements placed on the drying method. A fixedly pre-defined set of parameters for the drying procedure often does not correspond to the respective optimum parameters for the different portions of a drying method with a non-linear drying progression.

### SUMMARY OF THE INVENTION

It is an object of the present invention to provide a method of the type mentioned in the introduction for drying workpieces, which, by using information from the drying procedure, enables the process time for the drying procedure to be shortened and/or the energy required for the drying procedure to be reduced.

This object is achieved, according to the invention, with a method for drying workpieces having the features of the preamble of claim 1 in that
the feeding of fresh air to the feed air is reduced or interrupted during at least one monitoring period,
at least one measurement variable characterizing the drying procedure is measured by means of at least one sensor and a measurement signal of the at least one sensor is transferred to an evaluating unit of a control apparatus, and
from the evaluation of the measurement signal of the at least one sensor by means of the evaluating unit there is established an output variable which influences the further progression of the method.

Therein, the established output variable can be a parameter of the drying method which is amended as the result of the evaluation of the measurement signal of the at least one sensor, or the assessment of whether the at least one workpiece to be dried is sufficiently dried and thus the drying method can be ended.

In this description and in the appended claims, the expression “drying chamber” also comprises a cleaning chamber in which firstly a cleaning procedure on the at least one workpiece, and then a drying procedure, is carried out. The at least one workpiece to be dried can thus first be cleaned, and then dried, after its introduction into the drying chamber.

Underlying the present invention is the concept that at least one sensor for monitoring the drying method transfers data to an evaluating unit and, on the basis of the evaluation of these data by the evaluating unit, the drying method is regulated dynamically.

In addition thereto, status data of the drying plant used to carry out the method can also be transferred to the evaluating unit for evaluation, for example, an operating time of a heating apparatus for heating the feed air, opening and/or closing times of a valve for the feeding in of fresh air or for the removal of exhaust air, or suchlike.

In the evaluating unit, a process model is preferably implemented which comprises a control model and/or an AI (artificial intelligence) model for assessing a drying procedure.

The at least one sensor used can be, for example, a moisture sensor which monitors the drying progress.

On the basis of the evaluation of the drying progress by the evaluating unit, a parameter such as, for example, the fresh air feed, the process time of the hot air drying procedure and/or a switching cycle of a heating apparatus for heating the feed air can be regulated.

If the evaluating unit contains an AI model, this AI model can be taught in the course of simulations and/or advance tests in order to optimize target variables such as, for example, a drying time, a drying efficiency and/or an energy usage for the drying.

Such a control model or AI model that is taught, for example, by the manufacturer of a drying plant can then be utilized in the evaluating unit of a drying plant sold to a client.

Herein, the possibility exists that the control model or the AI model further optimizes itself during the operation of the drying plant at the client premises by way of the recording of relevant production data.

Such an optimization can take place discontinuously if, for example, after the collection of a sufficiently large dataset, on the basis of this larger database, a new and therefore potentially better AI model is calculated.

Alternatively or additionally thereto, it can be provided that the AI model continuously optimizes itself in that the AI model intentionally slightly varies at least one parameter of the drying procedure and assesses the influence of such a variation on the drying behavior. Variations that have a positive influence on the drying behavior are then adopted. This approach is also known as “reinforcement learning”.

The method according to the invention enables a monitoring of the drying procedure in order to guarantee a consistent quality during changing constraints (such as environmental humidity, workpiece type, workpiece mass, residual water quantity on the workpiece) of the drying method.

By way of the optimizing of parameters of the drying method, shorter process times can be achieved for the drying.

By way of the shortening of process times and the optimizing of parameters of the drying method, an energy saving can be achieved.

Preferably, the process model implemented in the evaluating unit, for example, a control model or an AI model can be configured such that it enables a pre-calculation of the drying time still required at a given time point until a sufficient drying of the at least one workpiece to be dried is enabled.

A duration of the at least one monitoring period can be at least one second and/or not more than 4 minutes, preferably not more than one minute, particularly preferably not more than 30 seconds.

If a control model is implemented in the evaluating unit, it is possible for regulation to be carried out between two moisture values by the control apparatus and the control procedure can only be interrupted if an upper limit value is exceeded.

It can further be provided that the at least one measurement variable characterizing the drying procedure is measured during a plurality of monitoring time periods, wherein the monitoring time periods can each be the same length or can have different lengths from one another.

During the evaluation of the at least one measurement signal, for example, a minimum and/or a maximum of the measurement signal can be established and used during the establishing of the output variable.

Furthermore, it can be provided that a rate of change of the at least one measurement variable is established and is used during the establishing of the output variable.

Alternatively or additionally thereto, it can be provided that a rate of change of a sum of at least two measurement variables and/or a rate of change of a difference between two measurement variables is established and is used in the establishing of the output variable.

The at least one sensor can comprise a moisture sensor, a temperature sensor, a thermal imaging camera for temperature monitoring the at least one workpiece to be dried, a pressure sensor and/or a weight sensor for measuring a mass change of the at least one workpiece to be dried.

A pressure sensor can be used, in particular, if as a component of the method for drying workpieces, a vacuum drying procedure is carried out.

It can further be provided that a sensor system is present for identifying a type of the at least one workpiece to be dried. From the type of the workpiece, conclusions can be drawn regarding the quantity of residual moisture typically adhering to the workpiece. In addition, the process time required for the drying of a workpiece is influenced by the geometry of the workpiece, in particular the presence of hollow spaces, blind holes and suchlike.

In preferred embodiments of the invention, it is provided that at least one sensor measures a measurement variable in the drying chamber, in a feed conduit for conducting feed air to the drying chamber, in a discharge conduit for discharging exhaust air from the drying chamber, in an exhaust air conduit for discharging exhaust air from an air circuit, in an evacuating conduit for connecting the drying chamber to a vacuum source, in an outlet conduit of a vacuum pump and/or in a surrounding area of the drying chamber.

In the evaluating unit, a process model is preferably implemented.

The process model can comprise a control model and/or an AI model for assessing a drying procedure.

It is particularly favorable if the process model is configured such that it can amend parameters of the drying method during the performance of a drying procedure or before the performance of a subsequent drying procedure in order to optimize the drying procedure.

The process model is preferably configured such that it can establish at least one optimum output parameter for the drying procedure on the basis of at least one input parameter transferred to the evaluating unit, wherein the output parameter is usable for controlling the drying procedure by means of the control apparatus.

In a particular embodiment of the invention, it is provided that the process model comprises an AI model which is configured such that it can optimize itself by changing at least one parameter of the drying procedure and by an assessment of the progression of the drying procedure.

The process model can be trained and/or optimized in a recipe-related or program-related manner.

Hard limits can be set for the process model, for example, a maximum temperature of the drying air. These hard limits can be set in a recipe-related or program-related manner.

The process model is preferably configured such that data regarding the workpieces to be dried are transferrable to the process model from outside a drying plant used for carrying out the drying procedure, preferably from a prior process carried out before the drying procedure or from a central master computer system.

The prior process can be, in particular, a manufacturing procedure for the workpiece to be dried, in particular a 3D-printing procedure or a processing procedure on the workpiece to be dried, for example, a procedure of cutting machining of the workpiece.

It is particularly favorable if the process model is configured such that data regarding the workpieces to be dried are transferrable to the process model by means of a sensor system, for example an imaging camera, by means of a barcode, by means of an RFID chip or by manual data input.

The sensor system by means of which data regarding the workpieces to be dried are transferrable to the process model, in particular the AI model, can itself also contain an AI model which, for example, can derive, from the transferred image information, workpiece data such as, for example, the type of the workpiece to be dried, the number of workpieces to be dried, the material from which the workpiece to be dried is formed, or suchlike.

Furthermore, it can be provided that the process model is configured in such a way that data regarding the quantity of liquid to be dried from the workpieces to be dried are transmissible to the process model by means of a sensor system, which is preferably arranged in the storage container for a cleaning medium, and/or from an additional-dosing apparatus for a cleaning medium.

From these data, the process model can draw conclusions regarding the process time needed and the energy requirement for the drying.

In a preferred embodiment of the invention, it is provided that the process model assesses the progression of the drying method and/or at least one parameter of the drying method is regulable by the control apparatus on the basis of at least one output of the process model.

In particular, from the assessment of the process model, it can be concluded whether the process time required for a sufficient drying of the at least one workpiece to be dried has elapsed.

The parameters of the drying method that are amendable by the control apparatus on the basis of the assessment by way of the process model can comprise, for example,
a temperature of the drying medium,
a heating output of an air conditioning apparatus,
an amendment of the volume flow of a drying medium (in particular, drying air) circulating in an air circuit,
an amendment of a volume flow of fresh air that is mixed into a volume flow of the drying medium (in particular, drying air) circulating in an air circuit,
a control of at least one movement device for moving the at least one workpiece to be dried in the drying chamber,
a switching on or switching off of at least one apparatus applying energy to the at least one workpiece to be dried in the drying chamber, for example,
an infrared radiator or a microwave generator,
a duration of a drying procedure
and/or
a change to a drying manner, for example a change from a hot air drying to
a vacuum drying.

The assessment of the progression of the drying procedure, which takes place in the evaluating unit, can comprise the calculation of a difference between moisture values and/or the calculation of a difference between temperature values.

Wherever, in this description or the associated claims, a moisture value is mentioned, this can be a value of a relative air humidity f, a value of an absolute air humidity pw or a value of a specific air humidity s.

The relative air humidity f is the ratio of the current water vapor pressure to the saturated vapor pressure.

The absolute air humidity pw is the mass of the water vapor per volume of air.

The specific air humidity s is the ratio of the mass of the gaseous water to the mass of dry air in which the gaseous water is contained.

The difference between moisture values can be, in particular, the difference between a moisture value of the exhaust air conducted out of the drying chamber and a moisture value of the feed air fed to the drying chamber. In this case, the difference in moisture values gives the difference between the air status before and after its passage through the drying chamber.

From a difference also between the temperature of the exhaust air that is conducted out of the drying chamber and the temperature of the feed air which is fed to the drying chamber, a conclusion can be drawn regarding the drying status of the at least one workpiece to be dried that is situated in the drying chamber. Since for the vaporization or evaporation of moisture from the workpiece to be dried, energy has to be expended, the temperature falls when the air passes through the drying chamber, provided moisture still vaporizes or evaporates from the workpiece to be dried. For such an assessment of the drying status on the basis of a temperature difference, a heating apparatus for heating the feed air must be switched off.

An assessment that the drying procedure is completed can be generated by way of an automated monitoring process and/or by way of the input by an operating person on the control apparatus.

The assessment that a workpiece in the drying chamber has been sufficiently dried can be transferred to the evaluating unit by a process step downstream of the drying procedure.

The evaluating unit can be located adjacent to the drying chamber or remotely from the drying chamber, for example, in a cloud application.

In particular, it can be provided that in a process step downstream of the drying procedure, the quality of the dried workpiece that is further processed in the downstream process step is declared as being in order or not in order and this assessment is transferred to the evaluating unit.

The at least one sensor can transfer its measurement signal by means of a wired connection to the control apparatus, in particular, to the evaluating unit of the control apparatus.

Alternatively or additionally thereto, it can also be provided that at least one sensor transfers its measurement signal to the evaluating unit by means of a wireless connection, for example, a WLAN connection, a Bluetooth connection or a radio connection.

In a particular embodiment of the invention, it is provided that at the start of a hot air drying procedure, the fresh air feed is reduced or interrupted in order thereby to achieve a faster heating of the at least one workpiece to be dried in the drying chamber. In this case, the air in the circuit is fed through the drying chamber and through an air conditioning apparatus to heat the air without cooler fresh air being mixed into this circulating air.

The heating duration, during which the fresh air feed is reduced or interrupted at the start of the hot air drying procedure, can be specified dependent upon the type and/or the number of the workpieces to be dried or can be established by means of the evaluating unit dependent upon the progression of the at least one measurement signal of the at least one sensor.

Furthermore, in a particular embodiment of the invention, it can be provided that during a hot air drying procedure, the specific air humidity s, the absolute air humidity pw and/or the relative air humidity f is maintained in a defined value range by regulating the fresh air feed and/or the heating output of the air conditioning apparatus.

The optimum value range for the air humidity in question can be specified manually, and/or established by way of a control model or an AI model which is implemented in the evaluating unit, and can preferably be amended during the hot air drying procedure.

Furthermore, in a particular embodiment of the method according to the invention, it can be provided that after the introduction of the at least one workpiece to be dried into the drying chamber, a vacuum drying procedure, then a hot air drying procedure, and thereafter a further vacuum drying procedure is carried out.

By way of the performance of a vacuum drying procedure before the first hot air drying procedure, moisture is boiled out of hollow spaces in the workpiece, so that a subsequent hot air drying procedure can be carried out more efficiently. Herein, a plurality of cycles can be carried out, each comprising a hot air drying procedure and a vacuum drying procedure.

The present invention further relates to a plant for drying workpieces, the plant comprising the following:
a drying chamber;
an air circuit which comprises a feed conduit for feeding feed air into the drying chamber and a discharge conduit for discharging exhaust air from the drying chamber; and
a regulable fresh air feed for feeding fresh air to the feed air before its entry into the drying chamber.

It is a further object of the present invention to provide such a plant for drying workpieces, by means of which for the drying of a workpiece, a shorter process time and/or a lower energy expenditure can be achieved.

For the achievement of this object according to the invention, the plant for drying workpieces further comprises the following:
a control apparatus which comprises an evaluating unit; and
at least one sensor by means of which a measurement variable characterizing the drying procedure is measured and the measurement signal thereof is transferrable to the evaluating unit;
wherein the control apparatus is configured such that the feeding of fresh air to the feed air is reduced or interrupted during at least one monitoring period and the evaluating unit is configured such that, from the progression of the at least one measurement signal of the at least one sensor during the at least one monitoring period, it establishes an output variable which influences the further progression of the drying method carried out by means of the drying plant.

The fresh air fed to the feed air can be ambient air or another gas or another gas mixture, for example a processed high-purity drying air or nitrogen.

Since the drying air is conducted in an air circuit, the exhaust air conducted out of the drying chamber becomes the feed air which is fed to the drying chamber, wherein fresh air can have been fed to the feed air or part of the exhaust air can have been removed therefrom.

Particular embodiments of the plant according to the invention for drying workpieces have already been explained above in relation to particular embodiments of the method according to the invention for drying workpieces.

The plant according to the invention for drying workpieces is particularly suitable for carrying out the method according to the invention for drying workpieces.

The method according to the invention for drying workpieces is preferably carried out by means of the plant according to the invention for drying workpieces.

Further features and advantages of the invention are the subject matter of the following description and of the illustration in the drawings of an exemplary embodiment.

### BRIEF DESCRIPTION OF THE DRAWINGS

FIG. 1 shows a schematic representation of a drying plant by means of which a hot air drying and a vacuum drying of at least one workpiece arranged in a drying chamber can be performed; and

FIG. 2 shows a graphical representation illustrating a progression over time of a measured relative air humidity for a drying procedure by means of the drying plant represented in FIG. 1.

Identical or functionally equivalent elements are identified with the same reference signs in all the drawings.

### DETAILED DESCRIPTION OF THE INVENTION

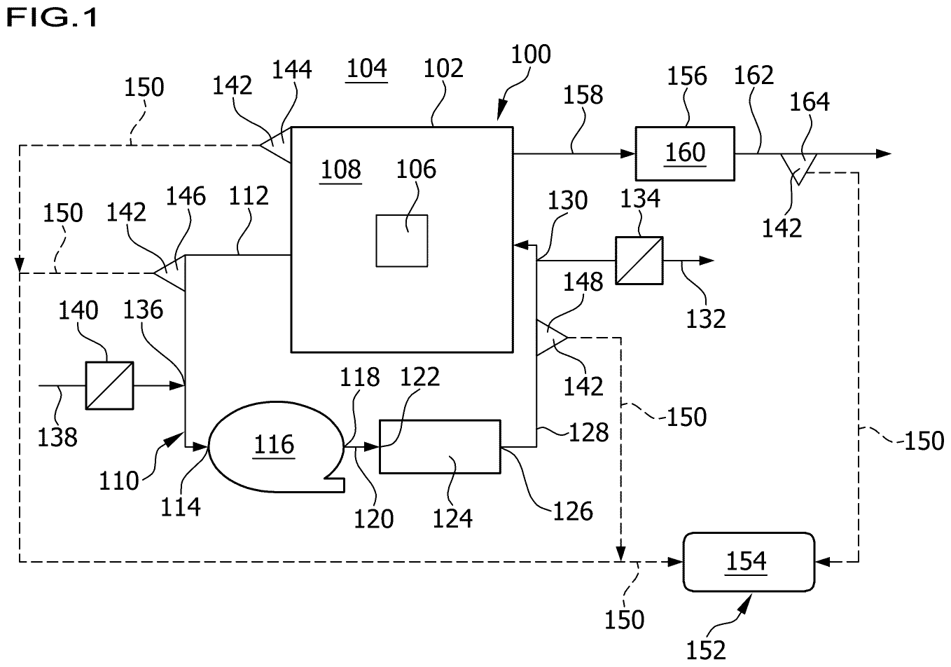

A drying plant shown in FIG. 1 and identified overall as 100 comprises a drying chamber 102 which is closable airtight relative to a surrounding area 104 of the drying chamber 102.

One or more workpieces 106 to be dried can be introduced into an interior 108 of the drying chamber 102.

In order to carry out a hot air drying procedure, the drying plant 100 comprises an air circuit 110 which comprises a discharge conduit 112 for discharging air out of the interior 108 of the drying chamber 102.

The discharge conduit 112 is connected to a suction-side inlet 114 of a blower 116.

From a pressure-side outlet 118 of the blower 116, an intermediate conduit 120 extends to an inlet 122 of an air conditioning apparatus 124.

The air conditioning apparatus 124 comprises, in particular, a heating apparatus for heating the air conducted through the air conditioning apparatus 124.

A feed conduit 128 extends from an outlet 126 of the air conditioning apparatus 124 back into the interior 108 of the drying chamber 102.

The exhaust air conducted out of the drying chamber 102 is therefore a portion of the feed air fed to the drying chamber 102.

Arranged in the feed conduit 128 is a branch 130 to which an exhaust air conduit 132 is attached.

The flow through the exhaust air conduit 132 is regulable by means of an exhaust air valve in the exhaust air conduit 132, for example, in the form of an exhaust air flap 134.

The discharge conduit 112 comprises a junction 136 at which a fresh air conduit 138 opens into the discharge conduit 112.

The flow through the fresh air conduit 138 is regulable by means of a fresh air valve arranged in the fresh air conduit 138, for example, in the form of a fresh air flap 140.

For monitoring the status of the air in the interior 108 of the drying chamber 102, in the discharge conduit 112 and in the feed conduit 128, the drying plant 100 comprises a plurality of sensors 142.

The sensors 142 can, in particular, comprise a drying chamber moisture sensor 144 for measuring the moisture in the interior 108 of the drying chamber 102, a discharge conduit moisture sensor 146 for measuring the air humidity in the discharge conduit 112 and/or a feed conduit moisture sensor 148 for measuring the air humidity in the feed conduit 128.

The discharge conduit moisture sensor 146 is preferably arranged upstream of the junction 136 of the fresh air conduit 138 with the discharge conduit 112.

The feed conduit moisture sensor 148 is preferably arranged upstream of the branch 130 of the exhaust air conduit 132 out of the feed conduit 128.

All the sensors 142 are connected by means of suitable data and control lines 150 to the control apparatus 152 of the drying plant 100.

The control apparatus 152 comprises an evaluating unit 154.

A process model for the drying procedure is implemented in the evaluating unit 154.

In order to be able also to carry out a vacuum drying procedure alternatively or alternatingly with the hot air drying by means of the drying plant 100, the drying plant 100 further comprises a vacuum source 156 which is connected to the interior 108 of the drying chamber 102 by means of an evacuating conduit 158.

The vacuum source 156 can comprise, for example, a vacuum reservoir and/or a vacuum pump 160.

If the vacuum source 156 comprises a vacuum pump 160, then an outlet conduit 162 is connected to an outlet of the vacuum pump 160.

In order to monitor the status of the air conducted out through the outlet conduit 162, the drying plant 100 can comprise a further sensor 142.

This sensor 142 can comprise, in particular, an outlet conduit moisture sensor 164.

The outlet conduit moisture sensor 164 is also connected by means of a suitable data and control line 150 to the control apparatus 152 of the drying plant 100.

The sensors 142 can be sensors for measuring the relative air humidity f, the absolute air humidity pw or the specific air humidity s.

The relative air humidity f is the ratio of the current water vapor pressure to the saturated vapor pressure.

The absolute air humidity pw is the mass of the water vapor per volume of air.

The specific air humidity s is the ratio of the mass of the gaseous water to the mass of dry air in which the gaseous water is contained.

It can also be provided that one, a plurality, or all of the sensors 142, in addition to measuring an air humidity, are also capable of measuring a temperature of the relevant air volume.

By means of the drying plant 100 described above, a method for drying workpieces in the drying chamber 102 is also carried out, for example, as follows:

The at least one workpiece 106 to be dried is introduced into the drying chamber 102 and the drying chamber 102 is closed relative to the surroundings 104.

Subsequently, at least one hot air drying procedure is carried out on the at least one workpiece 106 in the drying chamber 102.

In the hot air drying procedure, feed air is fed through the feed conduit 128 to the drying chamber 102, the air having been heated by means of the air conditioning apparatus 124.

At the same time, exhaust air is conducted out of the drying chamber 102 through the discharge conduit 112.

Fresh air from the fresh air conduit 138 is fed by way of the junction 136 to the feed air that is to be fed to the drying chamber 102 before its entry into the drying chamber 102.

For the monitoring of the hot air drying procedure, the respective relative air humidity f is measured by means of the sensors 142, in particular by means of the drying chamber moisture sensor 144, by means of the discharge conduit moisture sensor 146 and by means of the feed conduit moisture sensor 148, preferably substantially continuously, and evaluated in the evaluating unit 154 of the control apparatus 152 of the drying plant 100.

The relative air humidity f thus represents, in this embodiment of the method for drying workpieces 106, a measurement variable characterizing the drying procedure.

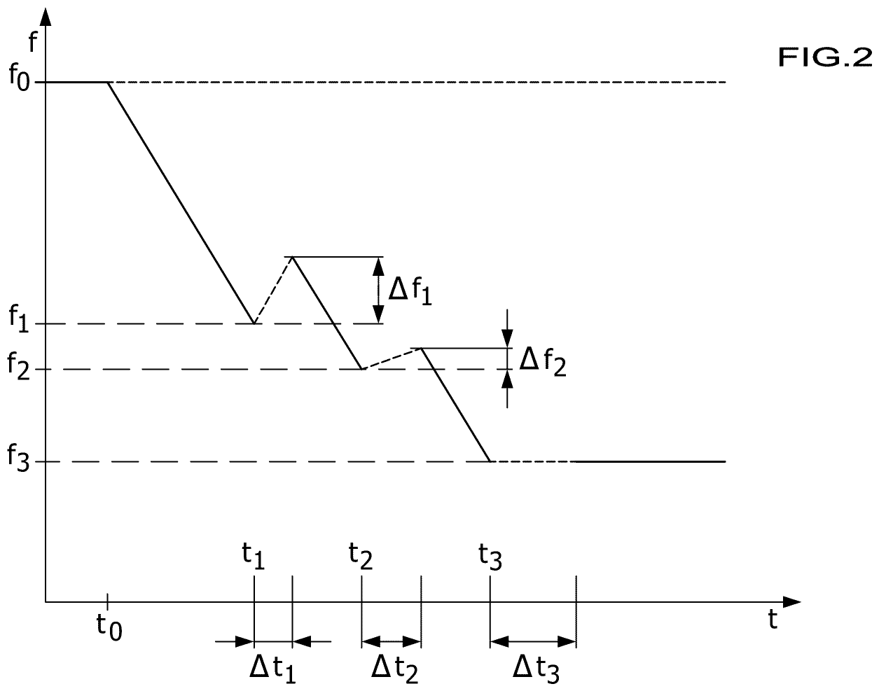

The sensor 142, the measurement signal of which is represented in FIG. 2, is, for example, the drying chamber moisture sensor 144, by means of which the relative air humidity f in the interior 108 of the drying chamber 102 is measured.

In the exemplary embodiment shown, the relative air humidity in the interior 108 of the drying chamber 102 at the start of the drying procedure (t=t₀) is f₀.

From the time point t₀ to the time point t₁, a hot air drying procedure is carried out in that air is conducted in a circulating manner through the air circuit 110 of the drying plant 100, wherein by means of the fresh air flap 140, fresh air is fed in and by means of the exhaust air flap 134, exhaust air is conducted out of the air circuit 110.

Moisture adhering to the at least one workpiece 106 to be dried vaporizes or evaporates and is carried out of the interior 108 of the drying chamber 102 with the exhaust air, whereby the relative air humidity f measured by the sensor 142 decreases from the output value f₀ to the value f₁.

At the time point t₁, the fresh air feed is prevented by closing the fresh air flap 140.

During a monitoring period following this of duration Δt₁ during which the fresh air flap 140 remains closed, the relative air humidity measured by the sensor 142 rises sharply since much moisture is still contained in the interior 108 of the drying chamber 102.

The removal of air through the exhaust air flap 134 is also prevented during the monitoring period by closing the exhaust air flap 134.

From the gradient of the progression of the measured air humidity over time, that is, from the ratio of Δf₁ to Δt₁, the evaluating unit 154 establishes the rate at which the characteristic measurement variable, in this case the relative air humidity, changes.

If this rate of change of the characteristic measurement variable is above a pre-determined (or established from an AI model implemented in the evaluating unit 154) limit value, the evaluation produces the result that the hot air drying procedure is not yet complete and the drying procedure is continued by opening the fresh air flap 140 and the exhaust air flap 134.

As can be seen in FIG. 2, the relative air humidity measured by the sensor 142 then falls until a time point t₂ at which the fresh air feed is again interrupted by the control apparatus 152 by closing the fresh air flap 140 and the exhaust air flap 134, specifically for a period Δt₂.

It can be provided that the duration Δt₂ depends upon the rate of change of the characteristic measurement variable f established in the preceding monitoring period.

In particular, it can be provided that the duration of the respective subsequent monitoring period increases if the rate of change of the characteristic measurement variable falls, in order thereby to obtain a sufficient resolution of the rise of the characteristic measurement variable until the end of the next monitoring period.

Again, the rate of change of the characteristic measurement variable is established in the evaluating unit 154 from the ratio of Δf₂ to Δt₂.

In the exemplary embodiment described, this rate of change in the second monitoring period is smaller, since only a little residual moisture remains in the interior 108 of the drying chamber 102.

If the rate of change of the characteristic measurement variable is above the pre-determined (or established from an AI model implemented in the evaluating unit 154) limit value, the hot air drying procedure is continued by the control apparatus 152 by opening the fresh air flap 140 and the exhaust air flap 134.

At a time point t₃ which is either fixedly pre-determined or has been established by an AI model implemented in the evaluating unit 154, the fresh air feed is again interrupted by the control apparatus 152 by closing the fresh air flap 140 and the exhaust air flap 134 for a further monitoring period of length Δt₃.

Again, the rate of change of the characteristic measurement variable, specifically the relative air humidity f, is established by the evaluating unit 154.

In the case illustrated in FIG. 2, however, the measured relative air humidity after the interruption of the fresh air feed remains constant (at the value f₃), which means that the rate of change of the characteristic measurement variable is zero.

Thus, the rate of change of the characteristic measurement variable is below the pre-determined limit value or below the limit value established by the AI model implemented in the evaluating unit 154.

In this way, the evaluating unit 154 assesses the drying procedure as being completed.

The hot air drying procedure is therefore brought to an end and the at least one workpiece 106 to be dried can be removed from the interior 108 of the drying chamber 102.

In this embodiment of a drying method, the assessment of whether the drying procedure is complete forms an output variable established by the evaluating unit.

Alternatively thereto, it can also be provided that after the evaluation of the rate of change of the characteristic measurement variable by the evaluating unit 154, rather than a hot air drying procedure, a vacuum drying procedure is carried out by the control apparatus 152, in the course of which the interior 108 of the drying chamber 102 is evacuated by way of the evacuating conduit 158 by means of the vacuum source 156.

A plurality of cycles of drying procedures in each of which a hot air drying procedure and a vacuum drying procedure are carried out alternatingly can follow one another during the drying of the at least one workpiece 106 in the drying chamber 102 until the evaluation undertaken by the evaluating unit 154 reveals that the drying target has been achieved and the at least one workpiece 106 to be dried can be regarded as sufficiently dry.

Rather than the measurement signal of the drying chamber moisture sensor 144, the signal of the discharge conduit moisture sensor 146 or of the feed conduit moisture sensor 148 can also be used by the evaluating unit 154 for establishing the output variable which influences the further course of the drying method.

Furthermore, it can also be provided that the evaluation of the measurement signal of the at least one sensor 142 by means of the evaluating unit 154 includes the calculation of a difference between the measurement signals from at least two sensors 142, for example, the calculation of a difference between the measurement signal of the discharge conduit moisture sensor 146 and the measurement signal of the feed conduit moisture sensor 148.

1. A method for drying workpieces, comprising the following:
introducing at least one workpiece to be dried into a drying chamber;
carrying out at least one hot air drying procedure wherein feed air is fed to the drying chamber and exhaust air is conducted out of the drying chamber;
wherein fresh air is fed to the feed air before its entry into the drying chamber;
wherein the feeding of fresh air to the feed air is reduced or interrupted during at least one monitoring period,
at least one measurement variable characterizing the drying procedure is measured by means of at least one sensor and a measurement signal of the at least one sensor is transferred to an evaluating unit of a control apparatus, and
from the evaluation of the measurement signal of the at least one sensor by means of the evaluating unit there is established an output variable which influences the further progression of the method.

2. The method according to claim 1, wherein a duration of the at least one monitoring period is at least one second and/or not more than 4 minutes.

3. The method according to claim 1, wherein a minimum and/or a maximum of the measurement signal is established and is used during the establishing of the output variable.

4. The method according to claim 1, wherein a rate of change of the measurement variable is established and is used during the establishing of the output variable.

5. The method according to claim 1, wherein the at least one sensor comprises a moisture sensor, a temperature sensor, a thermal imaging camera for temperature monitoring the at least one workpiece to be dried, a pressure sensor and/or a weight sensor for measuring a mass change of the at least one workpiece to be dried.

6. The method according to claim 1, wherein a sensor system is present for identifying a type of the at least one workpiece to be dried.

7. The method according to claim 1, wherein at least one sensor measures a measurement variable in the drying chamber, in a feed conduit for conducting feed air to the drying chamber, in a discharge conduit for discharging exhaust air from the drying chamber, in an exhaust air conduit for discharging exhaust air from an air circuit, in an evacuating conduit for connecting the drying chamber to a vacuum source, in an outlet conduit of a vacuum pump and/or in a surrounding area of the drying chamber.

8. The method according to claim 1, wherein in the evaluating unit, a process model is implemented which comprises a control model and/or an AI model for assessing a drying procedure.

9. The method according to claim 8, wherein the process model is configured such that it is able to amend parameters of the drying method during the performance of a drying procedure or before the performance of a subsequent drying procedure in order to optimize the drying procedure.

10. The method according to claim 8, wherein the process model is configured such that it is able to establish at least one optimum output parameter for the drying procedure on the basis of at least one input parameter transferred to the evaluating unit, wherein the output parameter is usable for controlling the drying procedure by means of the control apparatus.

11. The method according to claim 8, wherein the process model comprises an AI model which is configured such that it is able to optimize itself by changing at least one parameter of the drying procedure and by an assessment of the progression of the drying procedure.

12. The method according to claim 8, wherein the process model is configured such that data regarding the workpieces to be dried are transferrable to the process model from outside a drying plant used for carrying out the drying procedure, preferably from a prior process carried out before the drying procedure or from a central master computer system.

13. The method according to claim 8, wherein the process model is configured such that data regarding the workpieces to be dried are transferrable to the process model by means of a sensor system, for example an imaging camera, by means of a barcode, by means of an RFID chip or by manual data input.

14. The method according to claim 8, wherein the process model is configured such that data regarding the quantity of liquid to be dried from the workpieces to be dried are transmissible to the process model by means of a sensor system, which is preferably arranged in a storage container for a cleaning medium, and/or from an additional-dosing apparatus for a cleaning medium.

15. The method according to claim 8, wherein the process model assesses the progression of the drying method and/or at least one parameter of the drying method is regulable by the control apparatus on the basis of at least one output of the process model.

16. The method according to claim 8, wherein the parameters of the drying method that are amendable by the control apparatus on the basis of the assessment by way of the process model comprise a temperature of the drying medium, a heating output of an air conditioning apparatus, a change in the volume flow of a drying medium circulating in an air circuit, a change in a volume flow of fresh air that is mixed into a volume flow of the drying medium circulating in an air circuit, a control of at least one movement device for moving the at least one workpiece to be dried in the drying chamber, a switching on or switching off of at least one apparatus applying energy to the at least one workpiece to be dried in the drying chamber, for example, an infrared radiator or a microwave generator, a duration of a drying procedure and/or a change to a drying manner, for example a change from a hot air drying to a vacuum drying.

17. The method according to claim 1, wherein an assessment of the progression of the drying procedure comprises the calculation of a difference between moisture values and/or the calculation of a difference between temperature values.

18. The method according to claim 1, wherein an assessment that the drying procedure is completed is generated by way of an automated monitoring process and/or by way of input by an operating person on the control apparatus.

19. The method according to claim 1, wherein the assessment that a workpiece in the drying chamber has been sufficiently dried is transferred to the evaluating unit by a process step downstream of the drying procedure.

20. The method according to claim 1, wherein the evaluating unit is located adjacent to the drying chamber or remotely from the drying chamber, for example, in a cloud application.

21. The method according to claim 1, wherein at least one sensor transfers its measurement signal to the evaluating unit by means of a wireless connection, for example, a WLAN connection, a Bluetooth connection or a radio connection.

22. The method according to claim 1, wherein at the start of a hot air drying procedure, the fresh air feed is reduced or interrupted in order thereby to achieve a faster heating of the at least one workpiece to be dried in the drying chamber.

23. The method according to claim 1, wherein during a hot air drying procedure, a specific air humidity s, an absolute air humidity pw and/or a relative air humidity f is maintained in a defined value range by regulating the fresh air feed and/or the heating output of the air conditioning apparatus.

24. The method according to claim 1, wherein after the introduction of the at least one workpiece to be dried into the drying chamber, a vacuum drying procedure, then a hot air drying procedure and thereafter a further vacuum drying procedure is carried out.

25. A plant for drying workpieces, comprising the following:
a drying chamber;
an air circuit which comprises a feed conduit for feeding feed air into the drying chamber and a discharge conduit for discharging exhaust air from the drying chamber;
a regulable fresh air feed for feeding fresh air into the feed air before its entry into the drying chamber;
a control apparatus, which comprises an evaluating unit; and
at least one sensor by means of which a measurement variable characterizing the drying procedure is measurable and the measurement signal thereof is transferrable to the evaluating unit;
wherein the control apparatus is configured such that the feeding of fresh air to the feed air is reduced or interrupted during at least one monitoring period and the evaluating unit is configured such that, from the progression of the at least one measurement signal of the at least one sensor during the at least one monitoring period, it establishes an output variable which influences the further progression of the drying method carried out by means of the drying plant.

26. The plant according to claim 25, wherein the plant is configured to carry out a method for drying workpieces, comprising the following:
introducing at least one workpiece to be dried into a drying chamber;
carrying out at least one hot air drying procedure wherein feed air is fed to the drying chamber and exhaust air is conducted out of the drying chamber;
wherein fresh air is fed to the feed air before its entry into the drying chamber;
wherein the feeding of fresh air to the feed air is reduced or interrupted during at least one monitoring period,
at least one measurement variable characterizing the drying procedure is measured by means of at least one sensor and a measurement signal of the at least one sensor is transferred to an evaluating unit of a control apparatus, and
from the evaluation of the measurement signal of the at least one sensor by means of the evaluating unit there is established an output variable which influences the further progression of the method.
